(19) United States
(12) Patent Application Publication
(10) Pub. No.: US 2026/0259527 A1
(43) Pub. Date: Sep. 3, 2026

(54) PHOTOCONDUCTIVE SLEEVE SUPPORTS

(71) Applicant: HEWLETT-PACKARD DEVELOPMENT COMPANY, L.P., Spring, TX (US)

(72) Inventors: Peter NEDELIN, Ness Ziona (IL); Mark SANDLER, Ness Ziona (IL)

(73) Assignee: HEWLETT-PACKARD DEVELOPMENT COMPANY, L.P., Spring, TX (US)

(21) Appl. No.: 18/994,721

(22) PCT Filed: Jul. 19, 2022
(86) PCT No.: PCT/US2022/037635

§ 371 Date: Jan. 15, 2025

(51) Int. Cl. G03G 21/20; G03G 15/00; G03G 15/10

(52) U.S. Cl. CPC G03G 21/20; G03G 15/10; G03G 15/5045; G03G 15/751; G03G 2215/00084; G03G 2215/0658

(57) ABSTRACT

According to an example, a photoconductive sleeve support includes a core member rotatable about a rotation axis and an energy exchange member to receive a photoconductive sleeve and coupled to the core member. The energy exchange member is arranged such that an outer surface of the energy exchange member is to contact with an inner surface of the photoconductive sleeve and the energy exchange member includes an input port to receive heat transfer fluid from a fluid supply station.

### BACKGROUND

Liquid electro-photography (LEP) printing systems form images on substrates by transferring printing fluid profiles to the substrates. To obtain the printing fluid profile, a photoconductive element is selectively discharged. Subsequently, printing fluids are selectively transferred to the surface of the photoconductive element and the printing fluid profile is transferred to a subsequent transfer member. In some examples, the subsequent transfer member may be in the form of an intermediate element or a printing substrate.

### BRIEF DESCRIPTION OF DRAWINGS

Features of the present disclosure are illustrated by way of example and are not limited in the following figure(s), in which like numerals indicate like elements, in which:

FIG. 1A shows a schematic drawing illustrating a side view of a photoconductive sleeve support comprising an energy exchanger member, according to an example of the present disclosure;

FIG. 1B shows a schematic drawing illustrating a cross-sectional view of the photoconductive sleeve support of FIG. 1A;

FIG. 2A shows a schematic drawing illustrating a photoconductive sleeve support comprising a first and a second energy exchange members, according to an example of the present disclosure;

FIG. 2B shows a schematic drawing illustrating a cross-sectional view of the photoconductive sleeve support of FIG. 2A;

FIG. 3 shows a schematic drawing illustrating a photoconductive sleeve support comprising a front cup and a rear cup, according to an example of the present disclosure;

FIG. 4 shows a schematic drawing illustrating a photoconductive sleeve mounted on a photoconductive sleeve support, according to an example of the present disclosure;

FIG. 5 shows a printing system comprising a photoconductive sleeve support, a controller and a fluid supply station, according to an example of the present disclosure;

FIG. 6 shows a printing system comprising a photoconductive sleeve support, a sensor, a controller and a fluid supply station, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Liquid electro-photography (LEP) printing systems generate images on a printing substrate by transferring a printing fluid profile associated with the image to a printing substrate. To generate the printing fluid profile, a surface of the photoconductive element is electrically charged, selectively discharged, and then, printing fluids are selectively transferred to the surface of the photoconductive element with printing fluid developers such as binary ink developers. Once the printing fluid profile is generated on the photoconductive element, the printing fluid profile is transferred to a subsequent transfer element (e.g., an intermediate transfer member or a printing substrate).

Over a printing operation, liquid electro-photography (LEP) printing systems use charging elements to modify an electrical charge on a surface of the photoconductive element (e.g., a surface of a photoconductive drum). In an example, the printing system may comprise a charging member in the form of a charging roller to uniformly charge a surface of a photoconductive element of an LEP printing system at a reference voltage. Then, upon the photoconductive element is at the reference voltage, a discharging element (e.g., a writing head) may selectively discharge specific regions of the surface of the photoconductive element. Afterward, a binary ink developer (e.g., a developing unit) develops an electrically charged printing fluid such that the printing fluid is transferred to regions of the photoconductive element based on an electrical charge difference between the region and the electrical charge of the printing fluid. By subsequently engaging and disengaging other developing units of the LEP printing system, the printing fluid profile associated with the image is obtained on the surface of the photoconductive element. Then, once the printing fluid profile is completed, the printing fluid profile is transferred to the printing substrate or any other intermediate elements belonging to the printing system.

To effectively perform a transfer operation to a subsequent transfer member(s), each of the photoconductive element and the subsequent transfer member(s) have to be under specific conditions. In some examples, a temperature of the photoconductive element has to be within a range of temperatures to preserve the mechanical properties of the printing fluid forming the printing fluid profile. In some other examples, the printing fluid profile transferred to the subsequent transfer element may have to undergo a curing operation in which pores of the subsequent transfer element are opened using a drying station. Accordingly, the subsequent transfer element has to be within a range of temperatures to effectively cure and/or dry the printing fluid on the printing substrate.

As used herein, “printing fluid” refers generally to any substance that can be applied upon a substrate by a printing system during a printing operation, including but not limited to inks, electro-inks, primers, and overcoat materials (such as a varnish), water, and solvents other than water.

In some examples, excessive or deficient temperatures of the photoconductive element may negatively impact the printing system. In an example, excessive temperatures (e.g., temperatures higher than an upper limit of an operative range) may result in an early change of phase for the printing fluid, thereby leading to a deficient printing fluid profile on the surface of the photoconductive element. In other examples, when using printing fluid comprising resins, excessive temperatures may result in some particles of the printing fluid remaining adhered to the surface of the photoconductive element instead of being transferred to the subsequent transfer elements. To remove the adhered particles, the photoconductive element has to undergo a cleaning operation in which the particles are removed from the surface. In some other examples, deficient temperatures (e.g., temperatures lower than a bottom limit of the operative range) may result in a deficient energy transfer between the subsequent transfer member and the photoconductive element. In particular, the faulty energy transfer may result in a temperature decrease in the subsequent transfer member. In some examples, the temperature decrease in the subsequent transfer member may result in an ineffective curing operation, thereby leading to image quality issues such as deficient printing fluid transfers or deficient cleaning operations.

Disclosed herein are examples of photoconductive sleeve supports, printing systems, and photoconductive assemblies that maintain the components within a range of temperature associated with an operation to be carried out using the photoconductive sleeve support.

According to an example, a range of temperatures associated with an operating mode of the photoconductive sleeve support may be defined based on an operation to be performed by the printing system. In an example, when performing a printing operation, the photoconductive element may have to be at a temperature within a range between 30 and 50° C., in particular between 35 and 45° C., more particularly between 38 and 42° C. In other examples, when performing a quality enhancing process, the photoconductive element may have to be at a temperature within a range between 90 and 110° C., in particular between 95 and 105° C., more particularly between 98 and 102° C.

As used herein, “heating operation” will be used to refer to an operation of the printing system in which the temperature of the photoconductive element is increased using a heat source. In an example, a printing system may undergo a heating operation during a startup operation in which the components of the printing system are set under operative conditions or a quality enhancing process.

As used herein, “cooling operation” will be used to refer to an operation in which the temperature of the photoconductive element of the printing system is decreased using a cooling source. In an example, a printing system may have to a cooling operation that may be carried out during a printing transfer operation in which printing fluid profiles are generated on the photoconductive element and subsequently transferred to the subsequent transfer member.

According to an example, a printing system may have to perform heating or cooling operations so as to avoid image quality issues resulting from temperatures out of the operative ranges. In an example, a photoconductive element may be heated until reaching an operative state and cooled down during a printing operation. In other examples, external components may be used to dispense a heating agent or a cooling agent on the surface of the photoconductive element. However, the use of the external agents on the surface of the photoconductive element may result in agent dripping, lack of heat transfer capacity, additional costs associated with the wasted agents, or may even damage other components of the printing system.

As used herein, the term “photoconductive element” will be used to refer to elements including a replaceable film of photoconductive material. In some examples, the photoconductive element may be in the form of a photoconductive drum including a film of conductive material on an external surface. In some examples, the replaceable film may be made of aluminum. However, alternative materials may be possible. Examples of alternative materials comprise copper, steel, stainless steel, magnesium, titanium, and beryllium.

According to an example, a printing system may comprise a photoconductive sleeve support and a fluid supply station. The photoconductive sleeve support of the printing system comprises a core member rotatable about a rotation axis and an energy exchange member to receive a photoconductive sleeve. In particular, the energy exchange member may be arranged such that is coupled to the core member and an outer surface of the energy exchange member is to contact with the photoconductive sleeve. In use, the fluid supply station of the printing system is to supply the energy exchange member with heat transfer fluid via an input port, wherein the fluid supply station is to modify a temperature of the heat transfer fluid to a temperature associated with an operating mode. The operating mode may be associated with an operation to be carried out by the printing system. In some examples, the outer surface of the energy exchange member may reach a heating and cooling rate of up to 40 kW/m². In some examples, the outer surface of the energy exchange member may reach a heating and cooling rate within a range from 10 kW/m² to 40 kW/m², in particular a rate within a range from 20 kW/m² to 40 kW/m².

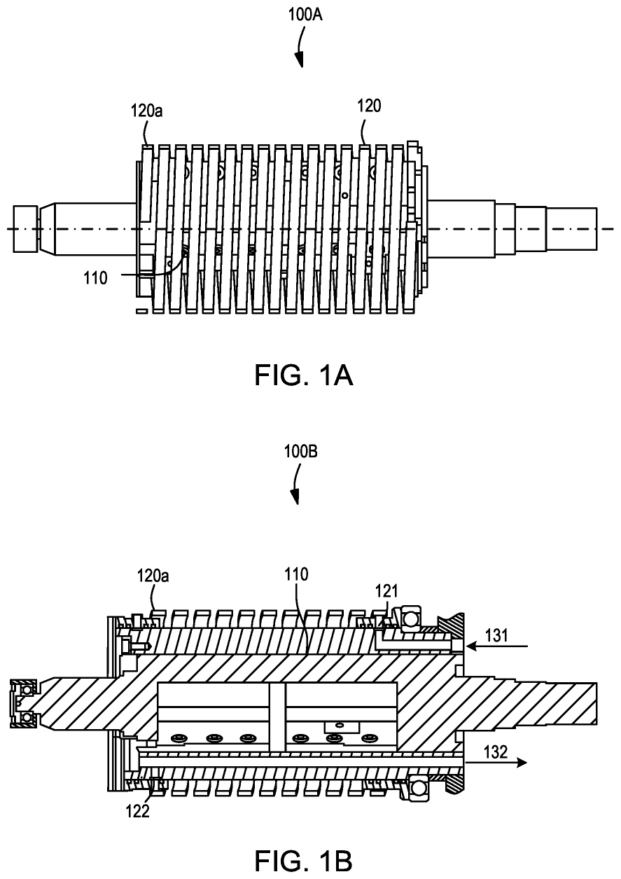

Referring now to FIG. 1A, a side view of a photoconductive sleeve support 100A is shown. The photoconductive sleeve support 100A may be used to keep a photoconductive sleeve under operative conditions. In particular, the photoconductive sleeve support 100A maintains the photoconductive sleeve at a temperature within a range of temperatures associated with an operating mode. The photoconductive sleeve support 100A comprises a core member 110 rotatable about a rotation axis (represented in dashed lines) and an energy exchange member 120 coupled to the core member 110. The energy exchange member 120 is to receive a photoconductive sleeve and is arranged such that an outer surface 120a of the energy exchange member 120 is to contact with an inner surface of the photoconductive sleeve.

In the photoconductive sleeve support 100A of FIG. 1A, the energy exchange member 120 includes an input port to receive a heat transfer fluid from a fluid supply station. In particular, the energy exchange member 120 is helically-shaped such that an outer surface of the energy exchange member 120 is to contact a large region of the photoconductive sleeve. In this fashion, the heat capacity of the energy exchange member 120 is increased, thereby increasing the temperature uniformity across the photoconductive sleeve. However, alternative shapes may be possible, such as a plurality of U-type energy exchangers, a plurality of spiral-type energy exchangers, or a combination thereof.

In some examples, the outer surface 120a of the energy exchange member 120 may have an outer surface curvature associated with the inner surface of the photoconductive sleeve. In particular, in some examples, the outer surface 120a of the energy exchange member 120 is arranged such that the curvature of the outer surface 120a matches the curvature of the inner surface of the photoconductive sleeve. As a result

Among others, one factor that contributes to the effectiveness of the heat transfer is a pressure exerted by the outer surface 120a of the energy exchange member 120 to the inner surface of the photoconductive sleeve. In some examples, the energy exchange member 120 may be coupled to the core member 110 via a plurality of biasing members so as to bias the energy exchange member 120 towards the inner surface of the photoconductive sleeve. Upon the photoconductive sleeve is received by the energy exchange member 120, the plurality of biasing elements is to bias the energy exchange member 120 towards the photoconductive sleeve. Examples of biasing elements comprise springs, gas canisters, or any element capable of recovering size and shape after deformation, for example, a deformation caused by the process transmitted forces.

As used herein, “energy exchange member” will be used to refer to a system used to transfer energy between a fluid moving through the energy exchange member and a second element contacting with an outer surface of the energy exchange member. Energy exchange members may be used to heat or cool down an object in contact with an outer surface of the energy exchange member. Examples of energy exchange members comprise helical heat exchangers, U-type heat exchangers, circular heat exchangers, finned tube heat exchangers, or coil heat exchangers. In an example, an energy exchange member may comprise a plurality of heat exchangers. In other examples, the pitch between adjacent elements of the heat exchanger may be set such that the desired heat capacity is obtained.

Referring now to FIG. 1B, a cross-sectional view of a photoconductive sleeve support 100B is shown. In an example, the photoconductive sleeve support 100B may correspond to the photoconductive sleeve support 100B previously explained in FIG. 1A. The photoconductive sleeve support 100B comprises a core member 110 and an energy exchange member 120 having an outer surface 120a to contact with an inner surface of a photoconductive sleeve. In FIG. 1B, the energy exchange member 120 is coupled to the core member 110 such that both elements jointly rotate about a common rotation axis.

The energy exchange member 120 of FIG. 1B comprises an input port 121 and an output port 122. In some examples, a fluid supply station may be fluidly connected to the energy exchange member 120 so as to supply heat transfer fluid to the energy exchange member 120. In an example, a fluid supply station may supply heat transfer fluid via an input line and the heat transfer fluid may be routed back to the fluid supply station via an output line. In FIG. 1B, an input arrow 131 represents a flow of heat transfer fluid towards energy exchange member 120 via the input port 121 and an output arrow 131 represents a flow of heat transfer fluid moving away from the energy exchange member 120 via the output port 122. In an example, a fluid supply station may move heat transfer fluid through the energy exchange member 120 via the input port 121 and the output port 122.

In some examples, the energy exchange member 120 of the photoconductive sleeve support 100B may comprise a sensor to measure a temperature of the heat transfer fluid at a sensing location of the energy exchange member 120. In an example, a plurality of sensors may be used to measure a temperature of the heat transfer fluid along the energy exchange member 120. In some examples, a controller may control the fluid supply station based on the measurements of the sensor (or plurality of sensors) distributed along the energy exchange member 120.

In some other examples, the core member 110 of the photoconductive sleeve support 100B may further comprise an alignment member to align a photoconductive sleeve with respect to the core member 110 (and hence, with respect the photoconductive sleeve support 100B). In an example, the alignment member may extend along an outer surface of the core member 110 and the alignment member may be to receive a corresponding alignment member of the photoconductive sleeve. In some examples, the alignment member may be in the form of a track extending along an outer surface of the core member 110 and the photoconductive sleeve may comprise a plurality of pins to be received by the track. Once each of the pins is inserted in its respective track, a movement of the photoconductive sleeve with respect to the core member 110 may be limited by the pin-track connection. Hence, when inserting the photoconductive sleeve. In an example, the track of the core member 110 may be arranged to correspond to the apertures defined by the shape of the energy exchange member 120. For instance, in the photoconductive sleeve support 100B, the track may be defined along portions of the surface of the core member 110 where a pin (or pins) of the photoconductive sleeve can pass through while not contacting the energy exchange member (for instance, the space available between adjacent turns).

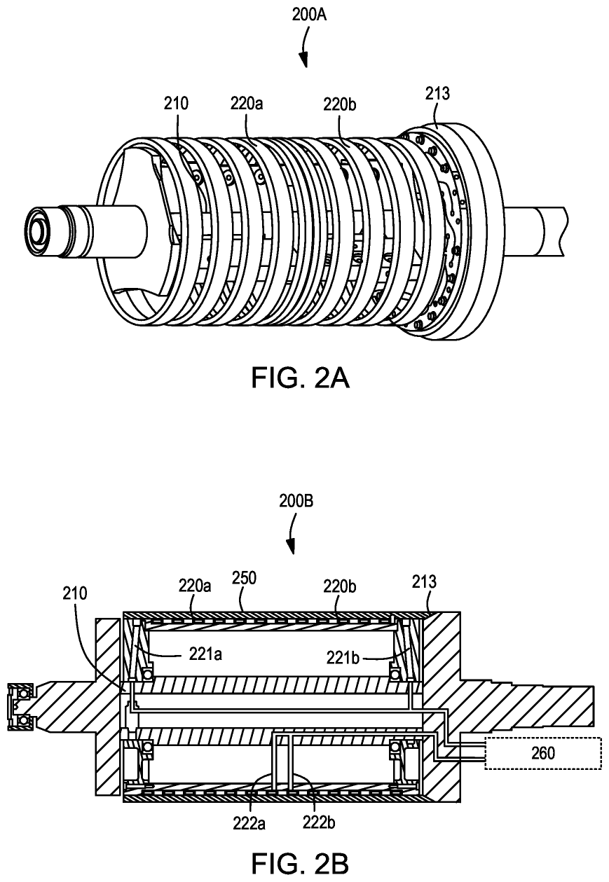

Referring now to FIG. 2A, a photoconductive sleeve support 200A comprising a first energy exchange member 220a and a second energy exchange member 220b is shown. The photoconductive sleeve support 200A further comprises a core member 210 rotatable about a rotation axis defined by a shaft extending from both sides of the core member 210. The first and second energy exchange members 220a and 220b are arranged along a length associated with a length of a photoconductive sleeve. In particular, the first and second energy exchange members 220a and 220b are to receive an inner surface of the photoconductive sleeve in their outer surface. In addition, the photoconductive sleeve support 200A further comprises a support member 213 to receive an edge of the photoconductive sleeve, the support member 213 protruding from the outer surfaces of the energy exchange members 220a and 220b.

In FIG. 2A, the energy exchange members 220a and 220b extend along different regions of the photoconductive sleeve support 200A and have their adjacent turns at a uniform distance (i.e., the pitch of the energy exchange members 220a and 220b is uniform). However, in other examples, the pitch and/or the width of the energy exchange members 220a and 220b may vary along the length of the photoconductive sleeve support 200A.

As previously explained, an energy exchange member is to receive heat transfer fluid from a fluid supply station via an input port and return heat transfer fluid to the fluid supply station via an output port. In the photoconductive sleeve support 200A, each of the energy exchange members 220a and 220b comprise a respective input port and a respective output port connectable to a fluid supply station. In some examples, the input ports may be arranged at opposite ends of the core member 210. For example, in the photoconductive sleeve support 200A, the output ports of the energy exchange member 220a and 220b may be located in an intermediate region of the core member 210 whereas the input ports may be located in opposite regions of the core member 210 (for instance, opposite ends of the core member 210).

In some examples, the support member 213 may include a ramp portion so as to receive a complementary element from the photoconductive sleeve. In this fashion, a position of the photoconductive sleeve with respect to the core member 210 is corrected as an edge of the photoconductive sleeve contact with the support member 213.

Referring now to FIG. 2B, a cross-sectional view of a photoconductive sleeve support 200B and a photoconductive sleeve 250 is shown. In an example, the photoconductive sleeve support 200B may correspond to the photoconductive sleeve support 200A previously explained in FIG. 2A. The photoconductive sleeve support 200B comprises a core member 210, a first energy exchange member 220a, and a second energy exchange member 220b. As previously explained, the energy exchange members 220a and 220b of the photoconductive sleeve support 200B are arranged such that an outer surface defined by the energy exchange members 220a and 220b is to receive an inner surface of a photoconductive sleeve. In FIG. 2B, a photoconductive sleeve 250 is mounted on the photoconductive sleeve support 200B. Also, for illustrative purposes, an external fluid supply station 260 in fluidic communication with the energy exchange members 220a and 220b has been represented in dashed lines. However, in other examples, the photoconductive sleeve support 200B may include the fluid supply station 260.

In the photoconductive sleeve support 200B represented in FIG. 2B, the first energy exchange member 220a comprises an input port 221a and an output port 222a. On the other hand, the second energy exchange member 220b comprises an input port 221b and an output port 222b. The input ports 221a and 221b have been arranged at opposite ends of the photoconductive sleeve support 200B. With respect to the output ports 222a and 222b, the output ports 222a and 222b are located in a middle region of the photoconductive sleeve support 200B. As a result, the photoconductive sleeve 250 will receive a first energy profile along the first half of the photoconductive sleeve support 200B (i.e., the portion including the first energy exchange member 220a) and a second energy profile along the second half of the photoconductive sleeve support 200B (i.e., the portion including the second energy exchange member 220b). In some examples, the first energy profile and the second energy profile may be symmetric with respect to an axial plane perpendicular to the core member 210 of the photoconductive sleeve support 200B.

In some examples, the energy exchange members 220a and 220b have to transmit a non-uniform energy profile along the inner surface of the photoconductive sleeve 250. In particular, the energy exchange members 220a and 220b may have to transmit additional energy to the ends of the photoconductive sleeve 250 compared to a middle region of the photoconductive sleeve 250 so as to compensate for the thermal losses towards the environment experienced via the edges of the photoconductive sleeve 250. In some examples, to increase the thermal capacity of the energy exchange members 220a and 220b along the regions associated with the edges of the photoconductive sleeve 250, the pitch of the energy exchange members 220a and 220b may be shorter along regions close by the edges of the core member 210 with respect to the pitch of the energy exchange members 220a and 220b along regions along a middle region of the core member 210.

As previously explained, the fluid supply station 260 is to supply heat transfer fluid to the first energy exchange member 220a via the input port 221a and the second energy exchange member 220b via the input port 221b. In particular, the fluid supply station 260 is to supply the heat transfer at a temperature associated with an operation of a printing system. In some examples, the fluid supply station 260 is further to control a flowrate of the heat transfer fluid based on the operating mode. In an example, the operating mode comprises a heating operating mode and a cooling operating mode. In the heating operating mode, the energy exchange members 220a and 220b heat the photoconductive sleeve 250. In the cooling operating mode, the energy exchange members 220a and 220b cool down the photoconductive sleeve 250.

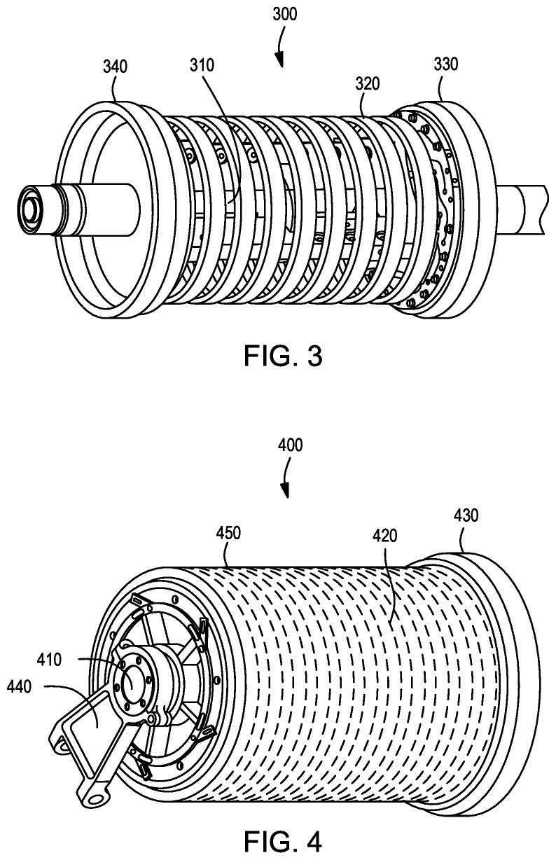

Referring now to FIG. 3, a photoconductive sleeve support 300 comprising a rear cup 330 and a front cup 340 is shown. The photoconductive sleeve support 300 further comprises a core member 310 rotatable about a rotation axis and an energy exchange member 320 coupled to the core member 310.

As previously explained, the photoconductive sleeve support 300 is arranged to receive a photoconductive sleeve such that an inner surface of the photoconductive sleeve contacts with an outer surface of the energy exchange member 320. As a result, a temperature of the inner surface of the photoconductive sleeve may be modified based on a temperature of the heat transfer fluid moving through the energy exchange member 320. In some examples, the energy exchange member 320 may be made of a thermal conductive material so as to effectively transmit energy from the heat transfer fluid to the inner surface of the photoconductive sleeve via the outer surface of the energy exchange member 320. Examples of thermal conductive materials comprise stainless steel and aluminum.

The photoconductive sleeve support 300 comprises the rear cup 330 and the front cup 340. The front cup 340, which is removable, is received by a projecting end of the core member 310 of the photoconductive sleeve support 300. The rear cup 330, on the other hand, is coupled to the core member 310. The rear cup 330 is arranged to contact a first end of the photoconductive sleeve and the front cup 340 is arranged to contact a second end of the photoconductive sleeve. In an example, the photoconductive sleeve is to be held in place by the front cup 340 and the rear cup 330. In other examples, the front cup 340 may comprise a locking member to fix a position of the front cup 340 with respect to the core member 310. In some other examples, each of the front cup 340 and the rear cup 330 may include alignment elements so as to effectively align the photoconductive sleeve with respect to the energy exchange member 320 in an accurate and repeatable manner.

Referring now to FIG. 4, a photoconductive sleeve support 400 and a photoconductive sleeve 450 in between a rear cup 430 and a front cup 440 of the photoconductive sleeve support 400 are shown. The photoconductive sleeve support 400 comprises an energy exchange member 420 coupled to a core member 410 that defines a rotation axis. In FIG. 4, the energy exchange member 420 (represented in dashed lines) is covered by the photoconductive sleeve 450. As a result, the inner surface of the photoconductive sleeve 450 is in contact with an outer surface of the energy exchange member 420. In some examples, the outer surface of the energy exchange member 420 may be arranged such that the geometry of the outer surface matches a geometry of the inner surface of the photoconductive sleeve. In an example, the outer surface of the energy exchange member 420 has an outer surface curvature associated to the inner surface of the photoconductive sleeve 450.

The energy exchange member 420 includes an input port (not shown in FIG. 4) to receive a heat transfer fluid from a fluid supply station. Examples of heat transfer fluid comprise at least one of ethylene glycol, propylene glycol, water, and synthetic oils. In some examples, the heat transfer fluid is a solution comprising ethylene glycol and water. In some examples, the energy exchange member 420 may be made of a thermally conductive material (e.g., copper) so as to effectively transfer heat and take up heat from the environment (or external elements in contact with the energy exchange member 420). In an example, the energy exchange member 420 may be made of a material having a thermal conductivity between 250 W/(m·K) and 450 W/(m·K). In some other examples, the thermal conductivity may be between between 300 W/(m·K) and 400 W/(m·K). In further examples, the energy exchange member 420 may reach a heat rate and a cooling rate of within a range from 10 kW/m² to 40 KW/m². In an example, the rate may be 20 kW/m².

As previously explained, the rear cup 430 and the front cup 440 of the photoconductive sleeve support 400 fix a position of the photoconductive sleeve 450 with respect to the components of the photoconductive sleeve support 400. In some other examples, the inner surface of the photoconductive sleeve 450 may comprise a plurality of leading pins extending in a radial direction and the photoconductive sleeve support 400 may further comprise corresponding alignment elements to receive the plurality of leading pins. The plurality of leading pins is to be received by the corresponding alignment elements such that the photoconductive sleeve 450 is at a respective configuration with respect to the support. In an example, the corresponding alignment elements may be a plurality of tracks on the core member 410 of the photoconductive sleeve support 400, wherein each of the leading pins is received by respective tracks by passing through an aperture defined between adjacent turns of the heat exchange member 420.

Although the energy exchange members explained in FIGS. 1A to 4 are formed of turns with a fixed width, in other examples, the turns defining the outer surface may have different widths and/or pitches based on the location of the turn with respect to the inner surface of the photoconductive sleeve. As explained above, the energy exchange member may be used to transmit a non-uniform energy profile to the inner surface of the photoconductive sleeve so as to compensate the thermal losses towards the environment.

In some examples, a heat exchange member may be in the form of a helical heat exchanger arranged such that an outer surface of the helical heat exchanger contacts at least 50% of the inner surface of the photoconductive sleeve. In some examples, the turns of the helical heat exchanger may be spatially distributed along a length associated with a length of the photoconductive sleeve so that a uniform energy profile is transmitted to the inner surface of the photoconductive sleeve.

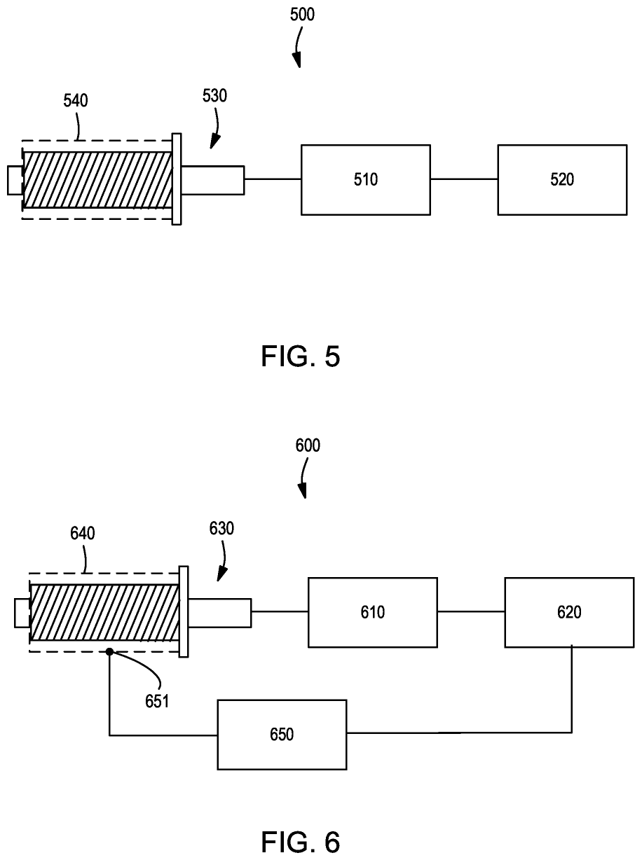

Referring now to FIG. 5, a printing system 500 comprising a fluid supply station 510, a controller 520, and a photoconductive sleeve support 530 is shown. In some examples, the photoconductive sleeve support 530 may correspond to one of the photoconductive sleeve supports 100A, 100B, 200A, 200B, 300, and 400. The photoconductive sleeve support 530 comprises a core member rotatable about a rotation axis and an energy exchange member coupled to the core member. The energy exchange member is in fluidic communication with the fluid supply station 510 and arranged such that an outer surface of the energy exchange member is to receive an inner surface of a photoconductive sleeve 540 (represented in dashed lines in FIG. 5).

As previously explained, the fluid supply station 510 of the printing system 500 is to supply heat transfer fluid to the energy exchange member at a temperature associated with an operating mode. The operating mode, in some examples, is associated with an operation to be carried out by the printing system 500. In FIG. 5, the controller 520 is to control the fluid supply station to supply heat transfer fluid at the temperature associated with the operating mode. In some examples, the operating modes comprise a heating operating mode and a cooling operating mode and the controller 530 is to control the fluid supply station 510 to supply to the energy exchange member of the photoconductive sleeve support 530 heat transfer fluid at a temperature between 70° C. and 105° C. in the heating operating mode and heat transfer fluid at a temperature between 5° C. and 20° C. in the cooling operating mode. In some examples, the heating operating mode may be selected during a startup operation of the printing system 500 in which the photoconductive sleeve 540 has to be heated to a reference temperature in which the transfer from the photoconductive sleeve 540 to a subsequent transfer member is effectively performed. In some other examples, the cooling operating mode may be selected during a printing operation in which the photoconductive sleeve 540 has to be cooled down so as to avoid image quality defects resulting from excessive temperatures on the photoconductive sleeve 540.

In some examples, the energy exchange member of the photoconductive sleeve support 530 may be in the form of a helical heat exchanger. In some other examples, the energy exchange member may be in the form of a first helical heat exchanger and a second helical heat exchanger arranged along a length associated with the photoconductive sleeve 540. In particular, the first helical heat exchanger may have a first input port in a first end of the core member of the photoconductive sleeve support 500 and the second helical heat exchanger may have a second input in a second end of the core member of the photoconductive sleeve support 530.

In some other examples, the energy exchange member of the photoconductive sleeve support 530 is a helical heat exchanger extending along a length associated to a length of the photoconductive sleeve 540, and the helical heat exchanger has a pitch within a range between 18 mm and 25 mm and a width within a range from 4 mm to 9 mm. In further examples, the helical heat exchanger is arranged such that an outer surface of the helical heat exchanger contact at least a 50% of the photoconductive sleeve 540.

According to some examples, a photoconductive sleeve support may include temperature sensors so as to measure a temperature of a region of the photoconductive sleeve. The region may correspond to an outer region of the photoconductive sleeve (e.g., an external surface on which the printing fluid is dispensed), an inner region of the photoconductive sleeve (e.g., the inner surface that contacts with the outer surface of the energy exchange member). In some other examples, the photoconductive sleeve support may include temperature sensors to measure a temperature of the heat transfer fluid moving the energy exchange member in multiple locations of the energy exchange member and the controller, based on the temperature difference, control the fluid supply station to modify a temperature of the heat transfer fluid.

Referring now to FIG. 6, a printing system 600 comprising a fluid supply station 610, a controller 620, a photoconductive sleeve support 630, and a sensor 650 to determine a temperature of a photoconductive sleeve support 640 is shown. The photoconductive sleeve support 640, which is represented in dashed lines, is to be received by a core member of the photoconductive sleeve support 630.

The temperature sensor 650 of the printing system 600 is to measure a temperature at a temperature location 651. In the printing system 600, the temperature location 651 corresponds to an external surface of the photoconductive sleeve 640. Then, once the sensor 650 has determined the temperature of the photoconductive sleeve 640, the determined temperature is sent to the controller 620, and the controller 620 controls the fluid supply station 610 based on the determined temperature. In an example, the sensor 650 determines a temperature of the photoconductive sleeve 640 as the fluid supply station 610 operates in a first operating mode and, upon the sensor 650 determines a threshold temperature, the controller 620 is to control the fluid supply station 610 to shift from the first operating mode to a second operating mode in which the fluid supply station 610 supplies heat transfer fluid at a different temperature. In an example, the first operating mode corresponds to a heating operating mode and the second operating mode corresponds to a cooling operating mode.

Although in the printing system 600 of FIG. 6 the sensor 650 is to shift the operating mode based on a temperature of the photoconductive sleeve 640, in other examples the temperature location 651 may be related to a temperature of the heat transfer fluid. The fluid supply station 610 is to supply the energy exchange member with heat transfer at a temperature associated with the operating mode and, as the heat transfer fluid moves along a fluid path defined by the energy exchange member, the temperature may change as a result of the thermal conduction between the energy exchange member and the photoconductive sleeve. In an example, the temperature location 651 may correspond to a location close to an output port of the energy exchange member. In other examples, the sensor 650 may measure temperature at multiple temperature locations and the controller may control the fluid supply station 610 based on the readings of the sensor 650.

In some other examples, the printing systems 500 and 600 may comprise additional components which may be used during at least one of a printing operation, a cleaning operation, and a conditioning operation. Examples of additional components include intermediate transfer members, binary ink developers, charging rollers, light-based printing heads, cleaning stations, and drying stations, among others.

According to an example, a photoconductive assembly may comprise a photoconductive sleeve, a fluid supply station, a controller, and a support to receive the photoconductive sleeve. The support may correspond, for instance, to the photoconductive sleeve support previously described in FIGS. 1a to 6. The energy exchange member of the support may be in the form of a helical heat exchanger and is arranged to contact with an inner surface of the photoconductive sleeve. The use of helical heat exchangers enables to transmit energy to external elements while reducing the overall costs associated with the materials of the heat exchanger and the systems used to move heat transfer fluid along the heat exchanger. As previously explained, the fluid supply station is to supply heat transfer fluid to an input port of the helical heat exchanger, and the controller is to control the fluid supply station to supply the heat transfer fluid at a temperature associated with an operating mode.

According to some examples, an inner surface of the photoconductive sleeve of the photoconductive assembly comprises a plurality of leading pins extending in a radial direction (i.e., the photoconductive sleeve has a cylindrical shape and the leading pins protrude towards a central axis of the cylinder) and the support comprises a corresponding alignment element to receive the plurality of leading pins. Upon the plurality of leading pins is received by the corresponding alignment elements, the photoconductive sleeve is aligned with respect to the support. In some examples, the plurality of leading pins may be distributed along the perimeter of the inner surface of the photoconductive sleeve. In an example, the corresponding alignment elements are tracks such that the tracks guide the leading pins to a respective configuration.

According to some other examples, the helical heat exchanger of the photoconductive assembly is arranged such that an outer surface of the helical heat exchanger contacts at least 50% of the inner surface of the photoconductive sleeve.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A photoconductive sleeve support comprising:
a core member rotatable about a rotation axis; and
an energy exchange member to receive a photoconductive sleeve and coupled to the core member, the energy exchange member including an input port to receive heat transfer fluid from a fluid supply station,
wherein the energy exchange member is arranged such that an outer surface of the energy exchange member is to contact with an inner surface of the photoconductive sleeve.

2. The support of claim 1, wherein the energy exchange member is a helical heat exchanger having an outer surface curvature associated to the inner surface of the photoconductive sleeve.

3. The support of claim 1, wherein the energy exchange member is coupled to the core member via a plurality of biasing elements, wherein upon the photoconductive sleeve is received by the energy exchange member, the plurality of biasing elements is to bias the energy exchange member towards the photoconductive sleeve.

4. The support of claim 1, wherein the core member further comprises:
an alignment member extending along an outer surface of the core member, wherein the alignment member is to receive a corresponding alignment member of the photoconductive sleeve.

5. The support of claim 1, wherein the core member further comprises:
a support member protruding from the outer surface of the energy exchange member, the support member to receive an edge of the photoconductive sleeve.

6. The support of claim 1, further comprising:
a rear cup coupled to the core member, the rear cup arranged to contact a first end of the photoconductive sleeve; and
a front cup to be received by a projecting end of the core member, the front cup arranged to contact a second end of the photoconductive sleeve,
wherein the photoconductive sleeve is to be held in place by the front cup and the rear cup.

7. A printing system comprising:
a fluid supply station to supply heat transfer fluid,
a controller to control the fluid supply station;
a photoconductive sleeve support to receive a photoconductive sleeve, the support comprising:
a core member rotatable about a rotation axis, and
an energy exchange member coupled to the core member, the energy exchange member in fluidic communication with the fluid supply station and arranged such that an outer surface of the energy exchange member is to receive an inner surface of the photoconductive sleeve,
wherein the controller is to control the fluid supply station to supply heat transfer fluid at a temperature associated with an operating mode.

8. The printing system of claim 7, wherein the operating mode comprises a heating operating mode and a cooling operating mode,
wherein the controller is to control the fluid supply station to supply:
heat transfer fluid at a temperature between 70° C. and 105° C. to the energy exchange member in the heating operating mode, and
heat transfer fluid at a temperature between 5° C. and 20° C. to the energy exchange member in the cooling operating mode.

9. The printing system of claim 7, wherein the printing system further comprises a sensor to determine a temperature of the heat transfer fluid, wherein the controller is to receive the determined temperature and the controller is further to control the heat transfer fluid supply station based on the determined temperature.

10. The printing system of claim 7, further comprising:
a sensor to determine a temperature of the photoconductive sleeve as the fluid supply station operates in a first operating mode,
wherein upon the sensor determines a threshold temperature, the controller is to control the fluid supply station to shift from the first operating mode to a second operating mode in which the fluid supply station supplies heat transfer fluid at a different temperature.

11. The printing system of claim 7, wherein the energy exchange member comprises:
a first helical heat exchanger having a first input port in a first end of the core member; and
a second helical heat exchanger having a second input port in a second end of the core member,
wherein the first input port and the second input port are in fluidic communication with the fluid supply station.

12. The printing system of claim 7, wherein the energy exchange member is a helical heat exchanger extending along a length associated to a length of the photoconductive sleeve, wherein the helical heat exchanger has a pitch within a range between 18 mm and 25 mm.

13. A photoconductive assembly comprising:
a photoconductive sleeve;
a support comprising:
a core member rotatable about a rotation axis;
a helical heat exchanger coupled to the core member and arranged to contact with an inner surface of the photoconductive sleeve;
a fluid supply station to supply heat transfer fluid to an input port of the helical heat exchanger; and
a controller to control the fluid supply station to supply heat transfer fluid at a temperature associated with an operating mode.

14. The photoconductive assembly of claim 13, wherein:
an inner surface of the photoconductive sleeve comprises a plurality of leading pins extending in a radial direction, and
the support comprises a corresponding alignment element to receive the plurality of leading pins,
wherein the plurality of leadings pins is to be received by the corresponding alignment elements such that the photoconductive sleeve is at a respective configuration with respect to the support.

15. The photoconductive assembly of claim 13, wherein the helical heat exchanger is arranged such that an outer surface of the helical heat exchanger contacts at least a 50% of the inner surface of the photoconductive sleeve.
